(19) United States
(12) Patent Application Publication
(10) Pub. No.: US 2015/0254636 A1
(43) Pub. Date: Sep. 10, 2015

(54) METHOD AND APPARATUS FOR PROVIDING MOBILE PAYMENT

(71) Applicant: Samsung Electronics Co., Ltd., Gyeonggi-do (KR)

(72) Inventors: Youngsik YOON, Gyeonggi-do (KR); Shinwoo Lee, Seoul (KR)

(73) Assignee: Samsung Electronics Co., Ltd.

(21) Appl. No.: 14/639,206

(22) Filed: Mar. 5, 2015

(30) Foreign Application Priority Data
Mar. 6, 2014 (KR) 10-2014-0026352

(51) Int. Cl. G06Q 20/32; G06Q 20/40

(52) U.S. Cl. CPC G06Q 20/3224; G06Q 20/40; G06Q 20/3278

(57) ABSTRACT

Provided are a method and an electronic device for recommending a form of payment to be used by a user when a mobile payment is made. The method includes determining, by an electronic device, whether the electronic device is located at a specific payment place; displaying, by the electronic device, a form of payment corresponding to the payment place on a predetermined area of a screen when the electronic device is determined to be located at the payment place; and performing, by the electronic device, a mobile payment when the displayed form of payment is selected.

### PRIORITY

This application claims priority under 35 U.S.C. §119(a) to Korean Patent Application No. 10-2014-0026352, which was filed in the Korean Intellectual Property Office on Mar. 6, 2014, the entire content of which is incorporated herein by reference.

### BACKGROUND OF THE INVENTION

1. Field of the Invention

The present invention relates generally to mobile payments, and more specifically, to a method and an apparatus for recommending a form of payment to be used when a mobile payment is made.

2. Description of the Related Art

Recently, developments in semiconductor and communication technology have gradually expanded the utility of portable electronic devices. In particular, portable electronic devices have been recently utilized to perform payment. For example, electronic devices may perform a charge payment related to public traffic by using near field wireless communication techniques. Electronic devices may also perform a payment service using the Internet by using mobile communication technology. Portable electronic devices have also been recently used to perform the functions of transportation cards and credit cards. Electronic device may also perform the functions of various coupons, mileage accumulation cards, etc. In order to perform such functions, the electronic device may display a barcode or a serial number, which is a unique IDentifier (ID), of a coupon or a mileage accumulation card, and a user may present the displayed information to a service provider to make a payment.

Mobile payment functions are advantageous, in that, even when a user does not possess various payment cards, mileage accumulation cards, etc., a user may still be able to easily make a corresponding payment. However, mobile payment functions are inconvenient in that it is cumbersome to select a payment means, which is to be used by a user, by executing a mobile payment program when a mobile payment is made.

### SUMMARY OF THE INVENTION

Accordingly, the present invention has been made to solve address the above-described problems and to provide at least the advantages described below.

A method and an apparatus for performing a mobile payment according to an embodiment of the present invention may display a payment means, which a user frequently uses at a specific place or is preset, on the screen of an electronic device and enables the user to promptly use the payment means.

In accordance with an aspect of the present invention, a method of performing a mobile payment is provided. The method includes determining, by an electronic device, whether the electronic device is located at a specific payment place; displaying, by the electronic device, a form of payment corresponding to the payment place on a predetermined area of a screen when the electronic device is determined to be located at the payment place; and performing, by the electronic device, a mobile payment when the displayed form of payment is selected.

In accordance with another aspect of the present invention, an electronic device for performing a mobile payment is provided. The electronic device includes a storage unit configured to store mobile payment related information; a communication unit configured to perform a communication function required for performing a mobile payment; a controller configured to control a display unit to display a form of payment corresponding to a payment place when the electronic device is determined to be located at a specific payment place, and to activate various functions required for performing the mobile payment according to a selection of the displayed form of payment; and the display unit configured to display the form of payment corresponding to the payment place on a predetermined area of a screen under a control of the controller.

### BRIEF DESCRIPTION OF THE DRAWINGS

The above and other aspects, features and advantages of certain embodiments of the present invention will be more apparent from the following detailed description in conjunction with the accompanying drawings, in which:

FIG. 1 is a diagram illustrating a configuration of an electronic device according to various embodiments of the present invention;

FIG. 2 is a flowchart illustrating an operation of recommending a form of payment during a mobile payment according to various embodiments of the present invention;

FIG. 3 is a diagram illustrating a mobile payment process according to various embodiments of the present invention; and

FIG. 4 is a flowchart illustrating a process of storing mobile payment information according to various embodiments of the present invention.

### DETAILED DESCRIPTION OF EMBODIMENTS OF THE PRESENT INVENTION

Hereinafter, various embodiments of the present invention are described with reference to the accompanying drawings. Throughout the drawings the same or similar elements may be designated by the same or similar reference numerals. Further, a detailed description of known functions and configurations may be omitted to avoid obscuring the subject matter of the present invention.

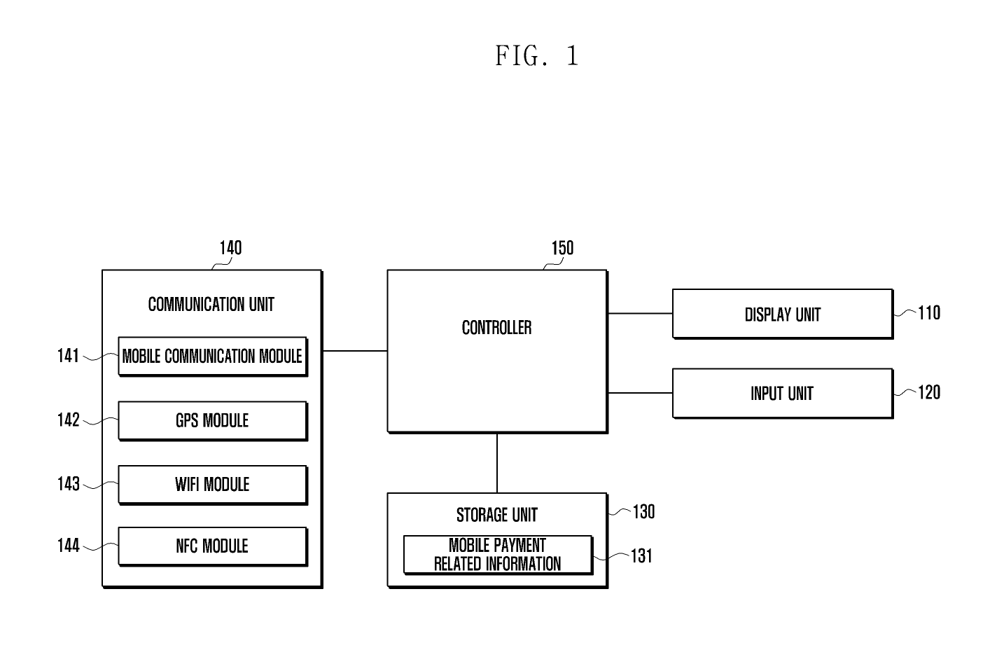

FIG. 1 is a diagram illustrating a configuration of an electronic device according to various embodiments of the present invention.

Referring to FIG. 1, the electronic device includes a display unit 110, an input unit 120, a storage unit 130, a communication unit 140, and a controller 150. Further, the storage unit 130 includes mobile payment related information 131, and the wireless communication unit 140 includes a mobile communication module 141, a Global Positioning System (GPS) module 142, a WiFi module 143, and a Near Field Communication (NFC) module 144.

The display unit 110 may be formed of a Liquid Crystal Display (LCD), Organic Light Emitting Diodes (OLED), Active Matrix Light Emitting Diodes (AMOLED), or the like. The display unit 110 visually provides a user with various information stored in the electronic device, such as images, documents, and videos. For example, the display unit 110 according to various embodiments of the present invention may display, as mobile payment related information 131, information indicating whether a pre-stored specific payment place (i.e., a “payment available place”) is located at a position adjacent to a user. Otherwise, when a user reaches a specific payment place (e.g., a movie theater or a restaurant), the display unit 110 may display whether the specific payment place is pre-stored in the storage unit 130 as the mobile payment related information 131. Further, when a user reaches a specific place, the display unit 110 may display a form of payment mapped to the place on a screen. In this case, the display unit 110 may immediately display the mapped form of payment on a lock screen image. The display unit 110 may also display a form of payment (for example, a mobile credit card or a mileage accumulation card) selected by a user on the screen, and display the form of payment for a user to confirm whether the form of payment is in a mobile payment available state on the screen. When the selected mobile form of payment (for example, a mobile credit card) performs a payment by photographing a barcode, the display 110 may display a barcode of the corresponding form of payment on the screen. In addition, when the display unit 110 registers the mobile payment related information, the display unit 110 may display a registration related page.

The input unit 120 may include a touch panel, an external key, and the like, and may perform a key input and a touch input into the electronic device. The input unit 120 enables a user to perform a touch input or a key input for selecting a form of payment displayed when the electronic device reaches a specific place. For example, the user may select a recommended form of payment displayed on the screen by using a method, such as a single touch, a double touch, or a drag. When a specific form of payment is selected through the operation, the user may perform a touch input or a key input for authenticating oneself by using the input unit 120. A user may use any of various authentication methods, such as pattern drawing or a password input to authenticate oneself.

The storage unit 130 stores a program and data required for operating the electronic device. The storage unit 130, according to an embodiment of the present invention, stores a mobile payment program required for performing a mobile payment. The storage unit 130 may also store the mobile payment related information 131 required for a mobile payment. The mobile payment related information 131 may include a mapping table, unique information about a mobile payment means, a payment history DataBase (DB), and the like. The mapping table includes data in which mapping information about a payment place and a form of payment is recorded. The information recorded in the mapping table may be newly generated when the user registers the information. Further, when the user accepts a form of payment, a place at which the mobile payment is performed, and the used form of payment may be automatically registered immediately after the mobile payment is performed. In this case, the form of payment may be called a concept, which may include a mobile credit card, a mobile check card, a mileage accumulation card, a coupon, a gift card, and the like.

The mapping table includes payment place related information and form of payment related information according to each place. The payment place related information may be registered as position information about a payment place (e.g., YY, XX-dong, Seoul), a business name (e.g., XX department store), and the like, where “XX” and “YY” are names of locations. Further, each element of the payment place related information may be classified into various kinds including a business type category. For example, the payment place related information may be classified into categories, such as a hospital, a gas station, a department store, and a restaurant, according to user settings.

Further, one or more forms of payment may be registered to one kind of payment place recorded in the mapping table. For example, when a payment place within the mapping table is a department store, all of the gift cards and credit cards for payment may be registered as a form of payment mapped to the department store. Further, when a plurality of forms of payment is registered, the user may select one of the recommended forms of payment displayed on the screen.

Further, unique information about the mobile forms of payment may include information related to a mobile exclusive form of payment issued for a mobile payment by the user, and may correspond to user information, a serial number of each payment means, and the like. Further, the unique information about the mobile forms of payment may contain sale information, a use condition, a serial number, and the like, of a coupon and a gift card.

The payment history DB includes data in which a history of a mobile payment by the user is recorded. When the mobile payment is performed, the user may not store the payment place and the form of payment in the mapping table. However, data related to the mobile payment may be stored in a payment history DB. The payment history DB may be used as a material for analyzing a characteristic of a mobile payment of the user, and for recommending a form of payment to the user based on the material. For example, when the electronic device reaches a payment place that is stored in the payment history DB, but is not included in the mapping table, the controller 150 may recommend a payment means that has been most frequently used at the payment place, based on the payment history DB.

The communication unit 140 supports wired and/or wireless communication performed by the electronic device. The communication unit 140 may include a wireless frequency transmitter for up-converting and amplifying the frequency of a transmitted signal, and a wireless frequency receiver for low-noise amplifying and down-converting a frequency of a received signal. Further, the communication unit 140 may include a mobile communication module 141, a GPS module 142, a WiFi module 143, an NFC module 144, and the like. The communication unit 140, according to various embodiments of the present invention, may perform a function for recognizing a position of the electronic device. In this case, the mobile communication module 141, the GPS module 142, and the WiFi module 143 may be operated in order to recognize a position of the electronic device. For example, the modules for recognizing the position may be operated in order to recognize the position of a specific point that the user reaches while moving, and the position of a specific point at which the mobile payment is performed.

Further, the communication unit 140 may perform a wired and/or wireless communication function for performing a mobile payment. A device used for performing the mobile payment may include, for example, the mobile communication module 141, the WiFi module 143, the NFC module 144, and the like. Although not illustrated in the drawing, modules for performing various communication functions may be added in accordance with embodiments of the present invention.

The controller 150 controls general operations of the electronic device. The controller 150, according to an embodiment of the present invention, controls the communication unit 140 so as to perform the mobile payment function according to a user's request for a mobile payment. For example, when the user executes the mobile payment program, the controller 150 may display a window, through which a mobile form of payment (e.g., a mobile credit card or a mobile gift card) available for a mobile payment is selectable, on a screen of the electronic device. Further, when the mobile payment is performed with the selected specific payment means, the controller determines whether to store a place at which the mobile payment is performed and the selected form of payment in the mapping table. When the user desires to store information about the mobile payment (e.g., the payment place and the form of payment used at the corresponding place) in the mapping table, the controller 150 may store the information in the mapping table of the storage unit 130. However, if the user does not desire to store information about the mobile payment in the mapping table, the controller 150 may store the information only in the payment history DB.

When the electronic device reaches a specific place according to the data recorded in the mapping table, the controller 150 controls the display unit 110 to display the form of payment on a predetermined area of the screen of the electronic device in order to recommend a form of payment mapped to the reaching position. In this case, the controller 150 recognizes a current position of the electronic device through information collected through the communication unit 140, and compares the recognized position of the electronic device and positions of payment places pre-stored in the mapping table. When it is determined that the currently approaching specific payment place is a place that is pre-stored in the mobile payment related information as a result of the comparison, the controller 150 controls the display unit 110 to display a form of payment to be recommended on the screen based on the mapping table. Further, when the controller 150 confirms that the recommended form of payment is selected, the controller 150 may display unique information (for example, a barcode) of the mobile form of payment or activate the NFC function demanded for the mobile payment so as to perform the payment using the selected payment means.

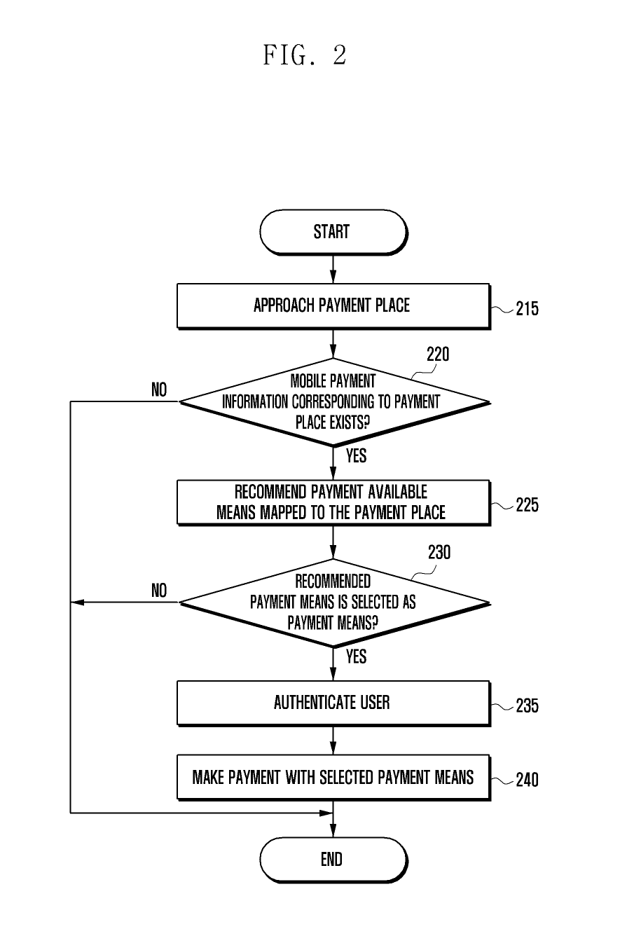

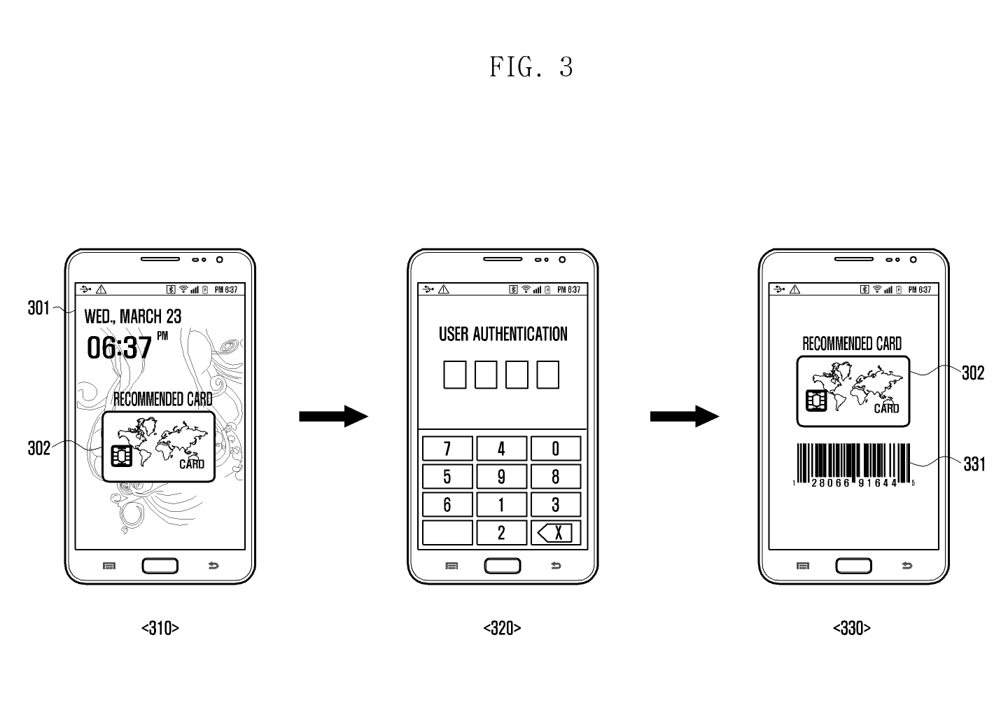

Hereinafter, an operation of the mobile payment according to an embodiment of the present invention is described as follows with reference to FIGS. 2 and 3.

FIG. 2 is a flowchart illustrating an operation of recommending a form of payment during a mobile payment according to various embodiments of the present invention.

Referring to FIGS. 1 and 2, the controller 150 accesses a predetermined payment place, in step 215. In the present example, the payment place refers to a place at which a payment is available, and may correspond to, for example, a restaurant, a movie theater, a department store, a café, a gas station, and the like. When the electronic device approaches the payment place, the controller 150 determines whether there exists any mobile payment information corresponding to the payment place, in step 220. The mobile payment information may include, for example, a mapping table that is data in which a form of payment is mapped with a specific payment place, a payment history DB storing a mobile payment history, and the like. The controller 150 checks information corresponding to the corresponding payment place, which is pre-stored based on the mapping table and the payment history DB. When there is not any mobile payment information corresponding to the current payment place, in step 220, the controller 150 terminates the process of FIG. 2. However, when there is mobile payment information corresponding to the current payment place, the controller 150 performs step 225. In step 225, the controller 150 recommends a payment available means mapped to the payment place. In this case, an available form of payment may include, for example, a credit card, a check card, a gift card, and a mileage accumulation for mobile and the like mapped to the payment place. In this case, the plurality of forms of payment may be mapped in the mapping table. For example, three forms of payment including a gift card, a credit card, and a mileage accumulation card, are all mapped to the same payment place, all three forms of payment may be recommended and displayed on the screen. However, when the plurality of forms of payment is recommended, the plurality of forms of payment may be divided and displayed so that any one of the plurality of recommended forms of payment is selected. Then, the controller 150 determines whether one of the recommended forms of payment is selected by a user, in step 230. When any one of the recommended forms of payment is selected by the user, the controller 150 authenticates a user, in step 235. When the user authentication is successfully completed, the controller 150 performs a payment operation with the selected form of payment, in step 240. For example, the controller 150 may generate and display a barcode for payment so that the payment is performed. Otherwise, the controller 150 may activate an NFC function within the electronic device so that the electronic device is linked with an NFC receiver provided at the payment place and the payment is performed. However, when the controller 150 cannot detect the selection of a specific form of payment among the recommended forms of payment, in step 230, the controller 150 terminates the process of FIG. 2.

FIG. 3 is a diagram illustrating a mobile payment process according to various embodiments of the present invention.

Referring to FIGS. 1 and 3, reference numeral 310 of FIG. 3 denotes a state where a mobile credit card 302, which is a recommended payment means, is displayed on a lock screen image 301 of the electronic device. When the electronic device reaches a specific place, and a form of payment is mapped to the place, the controller 150 displays the form of payment as denoted by reference numeral 310, and helps a user to immediately select the form of payment during a mobile payment. Further, the recommended form of payment is displayed on the lock screen image 301 as denoted by reference numeral 310. Meanwhile, a background screen image and a mobile payment program execution screen image may also be displayed according to various embodiments of the present invention. Further, according to various embodiments of the present invention, the form of payment displayed on a predetermined area of the screen may correspond to a mobile mileage accumulation card, a gift card, a coupon, and the like, in addition to a mobile credit card.

When the selection of the form of payment recommended as denoted by reference numeral 310 is confirmed, the controller 150 performs a user authentication process as denoted by reference numeral 320. Reference numeral 320 denotes an example in which a screen image for receiving input of a password preset by the user for user authentication is provided. In order for the user to perform user authentication, various methods, in addition to the input of the password denoted by reference numeral 320, may be used. Further, the process of the user authentication may be omitted, or an order thereof may be changed.

When the user authentication is completed, the controller 150 controls performance of the mobile payment by using the selected form of payment as denoted by reference numeral 330. Reference numeral 330 denotes an example in which the mobile credit card 302, which is the selected form of payment, is displayed on the screen to make a support so that the user may confirm the form of payment selected by the user itself. In this case, the controller 150 displays a barcode 331 for payment on the screen or activate the NFC function so that the mobile payment may be performed.

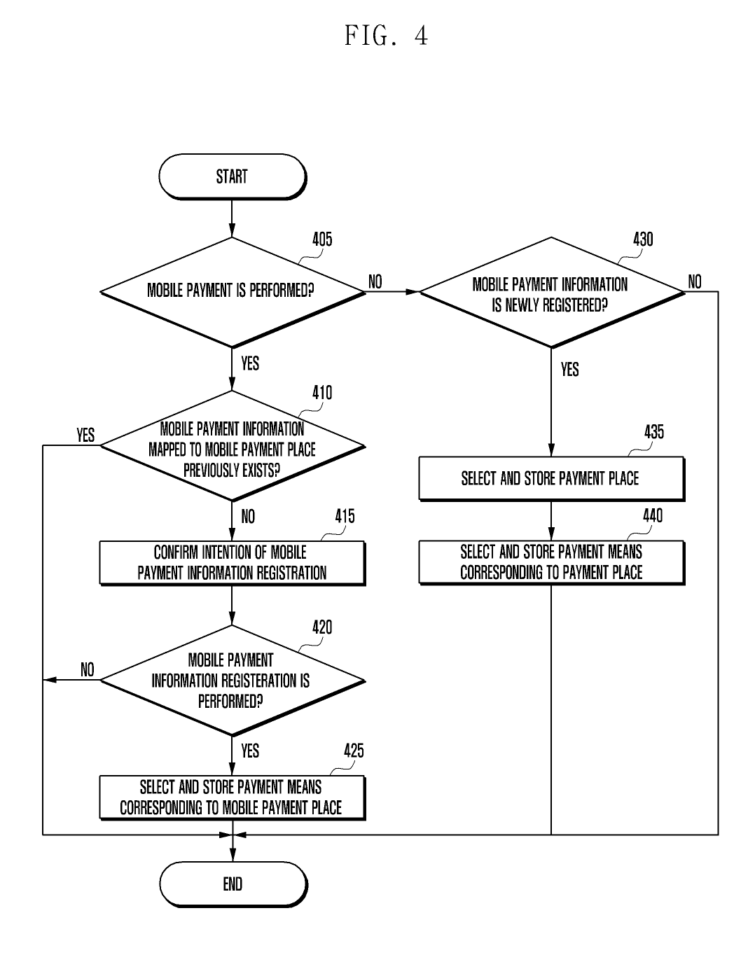

FIG. 4 is a flowchart illustrating a process of storing mobile payment information according to various embodiments of the present invention.

Referring to FIGS. 1 and 4, the controller 150 determines whether a mobile payment is performed, in step 405. Upon confirmation that the mobile payment is performed, the controller 150 determines whether there is mobile payment information mapped to a payment place at which the mobile payment is performed, in step 410. When information about the payment place, at which the mobile payment is performed, is included in mobile payment information pre-stored in the electronic device, the controller 150 confirms a mobile payment information registration intention, in step 415. In this case, the controller 150 displays a message or a User Interface (UI) inquiring whether to register the mobile payment information registration on the screen of the electronic device. When the user provides input indicating a desire to register the mobile payment information in connection with the performed mobile payment, in step 420, the controller 150 performs step 425. In step 425, the controller 150 selects and stores a form of payment corresponding to the mobile payment place, in step 425. In the present example, the stored information is stored in the mapping table.

When the mobile payment is not performed, in step 405, the controller 150 confirms whether a demand for a new registration of the mobile payment information is generated, in step 430. When a demand for the new registration of the mobile payment information is generated is not confirmed, the controller 150, terminates the process of FIG. 4. However, when the demand for the new registration of the mobile payment information is generated is confirmed, in step 430, the controller 150 performs a payment place selection and a storing operation, in step 435. Step 435 may also include a process of searching a web map, and the like. Further, the kinds of information related to the payment place may include a business name or position information. Further, after selecting the payment place, in step 435, the controller 150 selects and stores a form of payment corresponding to the selected payment place, in step 440. The payment place and the form of payment selected through the process are stored in the mapping table, and a plurality of forms of payment are mapped to a specific place.

Various embodiments of the present invention, such as the embodiments described above, may be implemented in the form of a program instruction that can be performed through various computers, and may be recorded in a computer readable recording medium. The computer readable recording medium may include a program command, a data file, and a data structure independently, or in combination. The program command recorded in the medium may be specially designed and configured for embodiments of the present invention, and may further include features that are well known to and can be used by those skilled in the computer software related art.

The computer readable recording media may include magnetic media, such as a hard disc, a floppy disc, and a magnetic tape, an optical recording media such as a Compact Disc Read Only Memory (CD-ROM) and a Digital Versatile Disc (DVD), a magneto-optical media such as a floptical disk, and a hardware device, such as a Read Only Memory (ROM), a Random Access Memory (RAM), and a flash memory, specifically configured to store and execute program instructions. A program command includes a machine language code generated by a compiler and a high-level language code executable by a computer through an interpreter and the like. The aforementioned hardware device may be configured to operate as one or more software modules in order to perform operations of various embodiments of the present invention, and vice versa.

Although embodiments of the present invention have been described in detail hereinabove, it should be clearly understood that many variations and modifications of the basic inventive concepts herein taught which may appear to those skilled in the present art will still fall within the scope and spirit of the present invention, as defined in the appended claims and their equivalents.

What is claimed is:

1. A method of performing a mobile payment, comprising:
determining, by an electronic device, whether the electronic device is located at a specific payment place;
displaying, by the electronic device, a form of payment corresponding to the payment place on a predetermined area of a screen when the electronic device is determined to be located at the payment place; and
performing, by the electronic device, a mobile payment when the displayed form of payment is selected.

2. The method of claim 1, wherein the specific payment place comprises a place corresponding to pre-stored place information as mobile payment related information.

3. The method of claim 2, wherein the mobile payment related information includes:
a mapping table, in which a respective form of payment to be used at each of a plurality of payment places is recorded,
unique information about a mobile form of payment, and
a payment history database, in which a mobile payment history is recorded.

4. The method of claim 3, wherein the mapping table includes payment place related information and forms of payment related information according to each payment place included in the mapping table, and
wherein the payment place related information is registered as position information and a business name, or the payment place related information is classified according to a business type category.

5. The method of claim 3, wherein the mapping table is stored by directly designating a predetermined payment place and a form of payment to be mapped to the predetermined payment place when data is newly registered, or by, when a mobile payment is performed at a previously non-registered payment place, automatically registering a place at which the mobile payment is performed and a form of payment used at the previously non-registered payment place according to an approval of a user.

6. The method of claim 1, wherein displaying the form of payment on the predetermined area of the screen includes, when a current position corresponds to a payment place recorded in a mapping table in the mobile payment related information, displaying a form of payment mapped to the payment place on the predetermined area of the screen.

7. The method of claim 6, wherein displaying the form of payment on the predetermined area of the screen includes displaying, when a current position corresponds to a payment place recorded in the history database in the mobile payment related information, a form of payment which is most frequently used in a payment history corresponding to the current payment place, on the predetermined area of the screen.

8. The method of claim 1, wherein the form of payment includes at least one of a card for payment, a mileage accumulation card, a mobile gift card, and a coupon used at a corresponding payment place.

9. The method of claim 1, wherein displaying the corresponding form of payment on the predetermined area of the screen includes displaying the corresponding form of payment on any one of a background screen image, a mobile payment program execution screen image, and a lock screen image.

10. The method of claim 1, wherein performing the mobile payment includes displaying unique information about the selected form of payment or activating a Near Field Communication (NFC) function for the mobile payment.

11. An electronic device for performing a mobile payment, comprising:
a storage unit configured to store mobile payment related information;
a communication unit configured to perform a communication function required for performing a mobile payment;
a controller configured to control a display unit to display a form of payment corresponding to a payment place when the electronic device is determined to be located at a specific payment place, and to activate various functions required for performing the mobile payment according to a selection of the displayed form of payment; and
the display unit configured to display the form of payment corresponding to the payment place on a predetermined area of a screen under a control of the controller.

12. The electronic device of claim 11, wherein the controller recognizes whether the specific payment place is a payment place pre-stored in mobile payment related information.

13. The electronic device of claim 11, wherein the storage unit stores a mobile payment related information, and the mobile payment related information comprises a mapping table, in which a respective form of payment to be used at each of a plurality of payment available places is recorded, unique information about a mobile payment means, and a payment history database, in which a mobile payment history is recorded.

14. The electronic device of claim 13, wherein the mapping table includes payment place related information and forms of payment related information according to each payment place included in the mapping table, and
the payment place related information is registered as position information and a business name, or is classified according to a business type category.

15. The electronic device of claim 13, wherein the mapping table is stored by directly designating a predetermined payment place and a form of payment to be mapped to the predetermined payment place when data is newly registered, or an operation of, when a mobile payment is performed at a previously non-registered payment place, automatically registering a place, at which the mobile payment is performed and a form of payment used at the previously non-registered payment place according to an approval of a user.

16. The electronic device of claim 11, wherein when a current position corresponds to a payment place recorded in a mapping table in the mobile payment related information, the controller displays a form of payment mapped to the payment place on the predetermined area of the screen.

17. The electronic device of claim 16, wherein when a current position corresponds to a payment place recorded in the history database in the mobile payment related information, the controller displays a form of payment that is most frequently used, in a payment history corresponding to the current payment place on the predetermined area of the screen.

18. The electronic device of claim 11, wherein the form of payment includes at least one of a card for payment, a mileage accumulation card, a mobile gift card, and a coupon used at a corresponding payment place.

19. The electronic device of claim 11, wherein when a current position is a pre-stored payment place, the display unit displays a form of payment corresponding to the payment place on any one of a background screen image, a mobile payment program execution screen image, and a lock screen image.

20. The electronic device of claim 11, wherein the controller performs an operation of displaying unique information about the selected form of payment or an operation of activating a Near Field Communication (NFC) function for the mobile payment in order to perform the mobile payment.
